(19) United States
(12) Patent Application Publication
(10) Pub. No.: US 2015/0242869 A1
(43) Pub. Date: Aug. 27, 2015

(54) METHOD AND SYSTEM FOR LINKING TRANSACTION DATA WITH EVENTS

(71) Applicant: MasterCard International Incorporated, Purchase, NY (US)

(72) Inventors: Kenny Unser, Fairfield, CT (US); Nikhil Malgatti, Stamford, CT (US); Serge Bernard, Danbury, CT (US); Kent Olof Niklas Berntsson, Rye, NY (US); Jean-Pierre Gerard, Croton-On-Hudson, NY (US)

(73) Assignee: MasterCard International Incorporated, Purchase, NY (US)

(21) Appl. No.: 14/259,650

(22) Filed: Apr. 23, 2014

Related U.S. Application Data
(63) Continuation-in-part of application No. 14/186,064, filed on Feb. 21, 2014, now abandoned.

(51) Int. Cl. G06Q 30/02

(52) U.S. Cl. CPC G06Q 30/0205

(57) ABSTRACT

A method for performing analytics processing in order to determine economic impact of an event on a particular market includes: receiving event information from an event storage unit, the event information including event data associated with an event and a venue in which the associated event occurred; receiving payment transaction information from a transaction storage unit, the payment transaction information including transaction data associated with each of a plurality of payment transactions; identifying a particular event and a particular venue associated with event data included in the received event information; identifying transaction data for payment transactions that occurred within a particular time frame of the particular event and within a specified area of a location of the selected event from the received payment transaction information; and determining an economic impact of the particular event on a particular market based on the identified transaction data.

This application is a continuation-in-part of U.S. Non-Provisional application Ser. No. 14/186,064, “Method and System for Linking Transaction Data with Events,” by Kenneth Unser et al., filed Feb. 21, 2014. The subject matter of the foregoing is herein incorporated by reference in its entirety.

### FIELD

The present disclosure relates to the performing of analytics processing to determine economic impact and consumer transaction behaviors for an event, specifically the use of transaction data corresponding to an event to identify an economic impact of the event on a particular market or transaction behaviors of consumers involved in or impacted by the event.

### BACKGROUND

Events may be held for a variety of reasons. There may be sporting events (e.g., the Super Bowl, World Series, March Madness, the Olympic Games, marathons, etc.), musical events (e.g., concerts, music festivals, award shows), entertainment events (e.g., movie openings, movie festivals, movie shootings, etc.), political events (e.g., elections, political party conventions, law change demonstrations, boycotts, etc.), and more. Each of these events may have a different effect on the economy of the local area or market as well as consumers themselves. It may be of interest to many entities, such as merchants, municipalities, business owners, employees, and consumers, to identify the impact that such events may have on a local market.

In an effort to determine such an impact, some methods have been created to assess the economic impact of an event. One such method includes reviewing tax revenue following an event. However, tax revenue is often not determined until a time significantly after an event, and may often be unable to be associated with a specific event, and therefore be an inaccurate estimation of an event's economic impact on a market. Another method includes identifying the number of attendees of an event, and then estimating additional spending of the attendees or other types or participants (whether willing or not) in the period before, during, and after the event, but due to the event. However, such a method may result in inaccuracies due to the estimation of the spending of the attendees, as well as the inability to account for additional consumers that may have been affected by the event without attending, such as security personnel, local business owners, journalists, photographers, etc.

Thus, there is a need for a technical solution to more accurately and more efficiently identify the economic impact of a particular event on a market.

### SUMMARY

The present disclosure provides a description of systems and methods for performing analytics processing to determine economic impact of an event on a particular market and consumer transaction behaviors associated with an event.

A method for performing analytics processing in order to determine economic impact of an event on a particular market includes: receiving, by a receiving device, event information from an event storage unit, the event information including event data associated with an event and a venue in which the associated event occurred; receiving, by the receiving device, payment transaction information from a transaction storage unit, the payment transaction information including transaction data associated with each of a plurality of payment transactions; identifying, by an analytics processing unit, a particular event and a particular venue associated with event data included in the received event information; identifying, by the analytics processing unit, transaction data for payment transactions that occurred within a particular time frame of the particular event and within a specified area of a location of the selected event from the received payment transaction information; and determining, by the analytics processing unit, an economic impact of the particular event on a particular market based on the identified transaction data.

A method for performing analytics processing in order to determine transaction behaviors associated with an event includes: receiving, by a receiving device, event information from an event storage unit, the event information including event data associated with an event and a location in which the associated event occurred; receiving, by the receiving device, payment transaction information from a transaction storage unit, the payment transaction information including transaction data associated with each of a plurality of payment transactions; identifying, by an analytics processing unit, a particular event associated with event data included in the received event information; identifying, by the analytics processing unit, transaction data for payment transactions that occurred within a particular time frame of the particular event and within a specified area of the location of the selected event from the received payment transaction information; and determining, by the analytics processing unit, consumer transaction behavior associated with the particular event based on the identified transaction data.

A system for performing analytics processing in order to determine economic impact of an event on a particular market includes a receiving device and an analytics processing unit. The receiving device is configured to receive: event information from an event storage unit, the event information including event data associated with an event and a venue in which the associated event occurred; and payment transaction information from a transaction storage unit, the payment transaction information including transaction data associated with each of a plurality of payment transactions. The analytics processing unit is configured to: identify a particular event and a particular venue associated with event data included in the received event information; identify transaction data for payment transactions that occurred within a particular time frame of the particular event and within a specified area of a location of the selected event from the received payment transaction information; and determine an economic impact of the particular event on a particular market based on the identified transaction data.

A system for performing analytics processing in order to determine transaction behaviors of an event on a particular area includes a receiving device and an analytics processing unit. The receiving device is configured to receive: event information from an event storage unit, the event information including event data associated with an event and a location in which the associated event occurred; and payment transaction information from a transaction storage unit, the payment transaction information including transaction data associated with each of a plurality of payment transactions. The analytics processing unit is configured to: identify a particular event associated with event data included in the received event information; identify transaction data for payment transactions that occurred within a particular time frame of the particular event and within a specified area of the location of the selected event from the received payment transaction information; and determine consumer transaction behavior associated with the particular event based on the identified transaction data.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for determining economic impact and consumer behaviors for an event in accordance with exemplary embodiments.

FIG. 2 is a block diagram illustrating the processing server of FIG. 1 for the determining of economic impact and consumer behaviors for an event in accordance with exemplary embodiments.

FIG. 3 is a flow diagram illustrating a process for analytically determining the economic impact of an event and consumer transaction behaviors associated thereby using the system of FIG. 1 in accordance with exemplary embodiments.

FIG. 4 is a diagram illustrating determined economic impact of a plurality of events on a particular market in accordance with exemplary embodiments.

FIG. 5 is a diagram illustrating a predicted future economic impact on a particular market based on past economic impacts of events on the particular or similar markets in accordance with exemplary embodiments.

FIG. 6 is a diagram illustrating determined consumer transaction behaviors associated with a plurality of events in accordance with exemplary embodiments.

FIG. 7 is a diagram illustrating predicted future consumer transaction behaviors for an event based on past consumer transaction behavior for similar events in accordance with exemplary embodiments.

FIG. 8 is a flow chart illustrating an exemplary method for performing analytics processing to determine economic impact of an event on a particular market in accordance with exemplary embodiments.

FIG. 9 is a flow chart illustrating an exemplary method for performing analytics processing to determine transaction behaviors associated with an event in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Determining Economic Impact and Transaction Behaviors of an Event

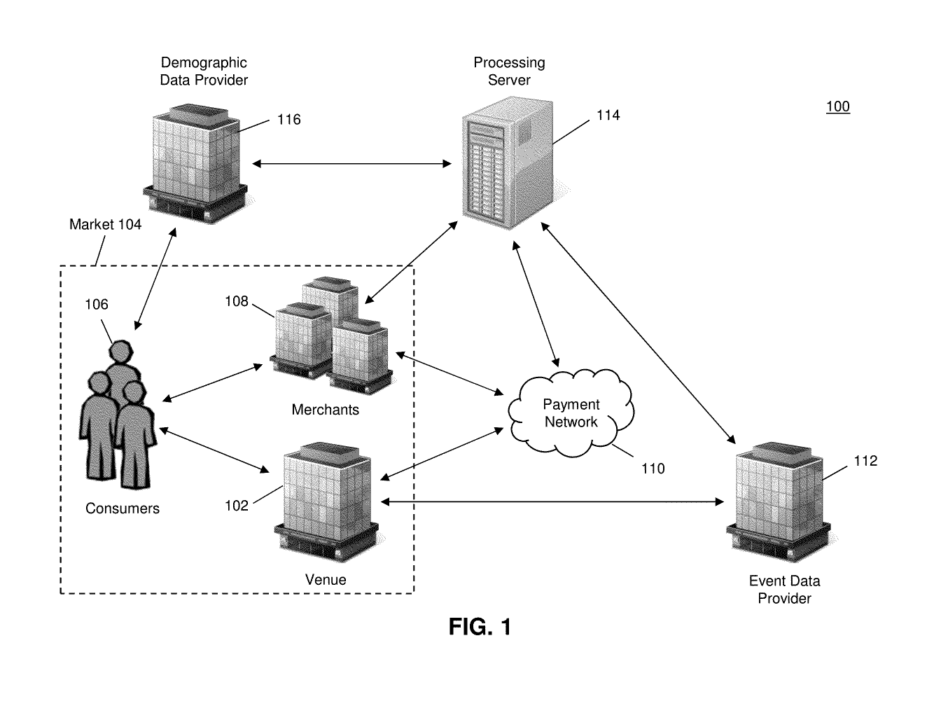

FIG. 1 illustrates a system 100 for the performing of analytics processing on transaction data in order to determine the economic impact of an event on a particular market and consumer transaction behaviors associated with the event.

The system 100 may include a venue 102. The venue 102 may hold an event. The event may be any type of event suitable for the determination of an economic impact of the event or transaction behaviors for consumers involved with or impacted by the event as discussed herein. The event may be a sporting event, musical event, entertainment event, social event, political event, or any other suitable type of event as will be apparent to persons having skill in the relevant art. The event may take place in a particular market 104. The particular market 104 may be a geographic area such as a neighborhood or municipality or other governmental demarcation, or other suitable type of market (e.g., transportation services) that may be economically impacted or that includes consumers 106 that may have been involved in or impacted by the event. In some instances, the venue 102 may be the particular market 104 (e.g., such as the United States due to a political event, such as announcement of election results).

The consumers 106 may include consumers that are directly involved in an event, such as consumers who attend the event or are directly employed as a result of the event (e.g., security personnel, concession employees, venue employees, etc.), as well as consumers that are indirectly involved or impacted by the event, such as local business owners, hospitality industry employees, or in some cases, any consumers located in the particular market 104. For example, in a political event, such as the change in a regime, every consumer 106 in the particular market 104 (e.g., the country or region in which the regime has changed), may be directly or indirectly impacted.

The particular market 104 may also include a plurality of merchants 108 that are impacted by the event. For example, the merchants 108 may include merchants in the hospitality industry (e.g., restaurants, hotels, bars, clubs, etc.), the travel industry (e.g., airlines, car rental agencies, taxi services, etc.), etc., that are effected by an event. The consumers 106 may transact with the merchants 108, as well as the venue 102 (e.g., to purchase tickets, concessions, etc.). The venue 102 and merchants 108 may each process transactions involving the consumers 106 via a payment network 110. The payment network 110 may process payment transactions using methods and systems that will be apparent to persons having skill in the relevant art. The payment network 110 may store transaction data associated with the transactions associated with the event (e.g., involving the consumers 106 and the venue 102 and merchants 108).

The system 100 may also include an event data provider 112. The event data provider 112 may obtain and store event data associated with an event, such as times and dates, the outcome of the event (e.g., which team won in a sporting event, which side won in an election, if a law passed or failed, etc.) data regarding the venue 102, the consumers 106, the particular market 104, and/or the merchants 108, and any other suitable information (e.g., conversion of political speech into data that can be processed such as by using CAMEO or IDEA codes as described below, security reports, etc.) for performing the functions as discussed herein as will be apparent to persons having skill in the relevant art. In some embodiments, the event data provider 112 may be the venue 102. In other embodiments, the event data provider 112 may be a third party that may or may not be a part of the particular market 104. Also, the event data provider 112 may be a number of separate entities.

The system may further include a processing server 114. The processing server 114, discussed in more detail below, may be configured to determine the economic impact of the event or transaction behaviors of the consumers 106 as a result of the event. The processing server 114 may receive event data from the event data provider 112. The processing server 114 may also receive transaction data from the payment network 110. In some instances, the processing server 114 may identify the particular event, and may request transaction data associated with the particular event (e.g., involving the venue 102 and merchants 108) from the payment network 110.

The processing server 114 may then determine an economic impact of the event based on the transaction data, as discussed in more detail below. In instances where the event data includes an outcome, the determined economic impact may be of the event with the corresponding outcome. For example, a baseball game between the Yankees and Red Sox may have a different economic impact if one team wins as opposed to the other. The processing server 114 may also be configured to determine transaction behaviors of the consumers 106 associated with the event based on the transaction data, as also discussed in more detail below. In some embodiments, the processing server 114 may also use additional information in order to determine the economic impact and/or transaction behaviors.

For example, in one embodiment, the system 100 may include a demographic data provider 116. The demographic data provider 116 may be configured to collect demographic data from the consumers 106, such as age, gender, income, occupation, education, residential status, familial status, marital status, zip code, postal code, etc. In some instances, the demographic data may not include any personally identifiable data. The demographic data provider 116 may provide the collected demographic data to the processing server 114. In some embodiments, the processing server 114 may request the demographic data for the consumers 106, based on identification of the consumers 106 using the transaction data. The processing server 114 may be configured to use the demographic data in determining economic impact and transaction behaviors, such as identifying the economic impact of an event on certain demographics.

In another embodiment, the processing server 114 may be configured to use merchant data in the determination of economic impact and/or consumer transaction behaviors. In such an embodiment, the processing server 114 may collect merchant data from the merchants 108, such as merchant industry, merchant category, business size, operating hours, geographic location, and other suitable data as will be apparent to persons having skill in the relevant art. The merchants 108 may provide the merchant data to the processing server 114. The processing server 114 may then utilize the merchant data, in addition to the transaction data, when determining economic impact and transaction behaviors of the event.

### Processing Server

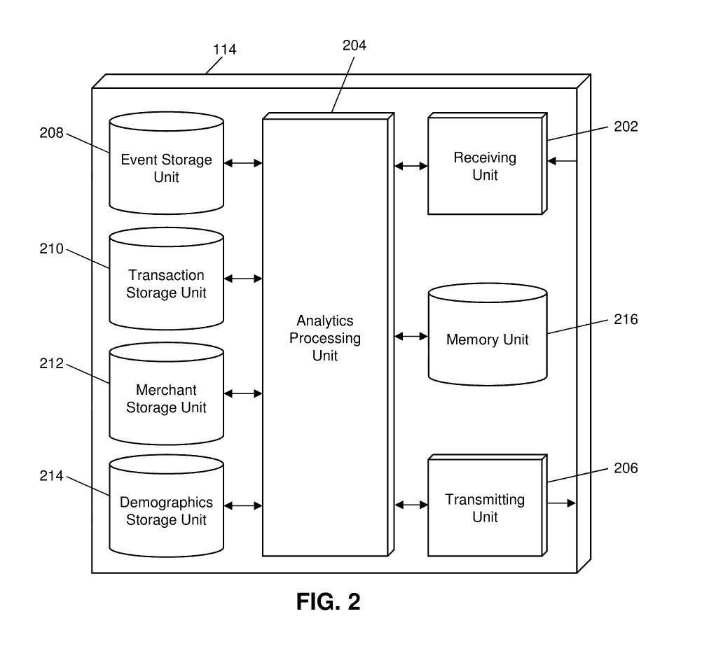

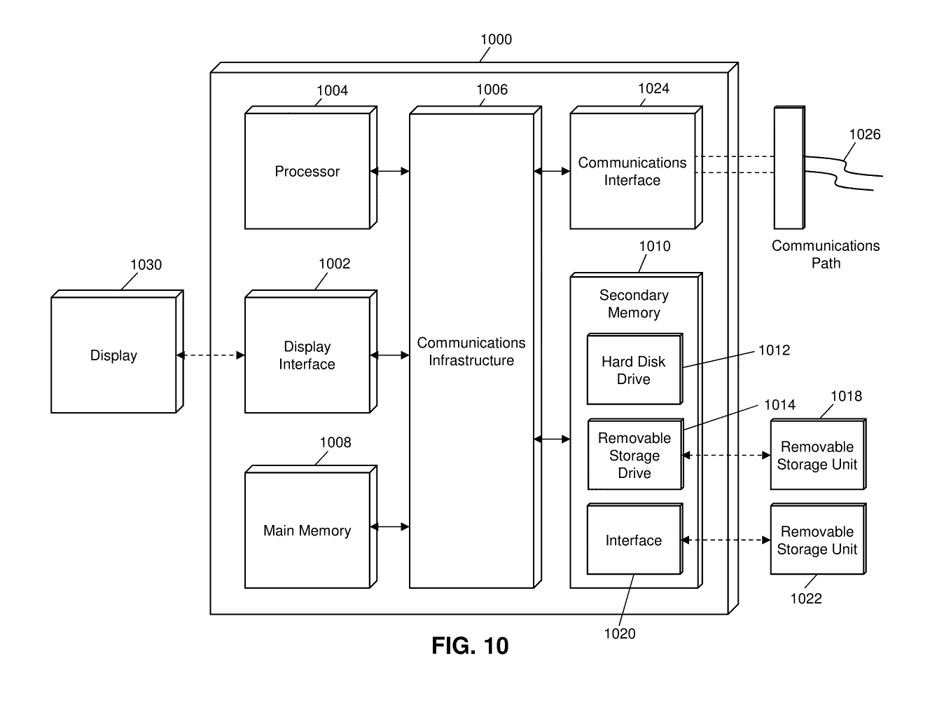

FIG. 2 illustrates an embodiment of the processing server 114 of the system 100. It will be apparent to persons having skill in the relevant art that the embodiment of the processing server 114 illustrated in FIG. 2 is provided as illustration only and may not be exhaustive to all possible configurations of the processing server 114 suitable for performing the functions as discussed herein. For example, the computer system 1000 illustrated in FIG. 10 and discussed in more detail below may be a suitable configuration of the processing server 114.

The processing server 114 may include a receiving unit 202. The receiving unit 202 may be configured to receive data over one or more networks via one or more network protocols. The receiving unit 202 may receive event data from the event data provider 112 and/or the venue 102. The event data may be stored in an event storage unit 208. In some embodiments, the event storage unit 208 may be included in the event data provider 112, and provided to the processing server 114 via the receiving unit 202.

The receiving unit 202 may also receive transaction data from the payment network 110, the merchants 108, and/or the venue 102. The transaction data may be stored in the transaction storage unit 210. In some embodiments, the transaction storage unit 210 may be included in the payment network 110, and the transaction data included therein provided to the processing server 114 by the payment network 110 and received by the receiving unit 202. The transaction data may include transaction times and/or dates, product data, consumer data, merchant data, transaction amounts, geographic locations, and any other suitable data associated with payment transactions as will be apparent to persons having skill in the relevant art.

The receiving unit 202 may also receive merchant data from the merchants 108 and/or demographics data from the demographic data provider 116. The received merchant data and demographic data may be stored in a merchant storage unit 212 and a demographics storage unit 214, respectively. In some embodiments, the merchant storage unit 202 and/or the demographics storage unit 214 may be included in the merchants 108 and the demographic data provider 116, respectively.

In some embodiments, the receiving unit 202 may also receive a request for economic impact of an event. The request may identify a particular event and/or a particular market (e.g., the particular market 104) for which the economic impact is requested. The receiving unit 202 may also be configured to receive a request for consumer transaction behavior associated with a particular event. The request may include information identifying the particular event. In some instances, the request may further include demographics information, merchant information, and/or consumer information for use in identifying consumer transaction behaviors for specific groups of consumers, merchants, etc.

The processing server 114 may also include an analytics processing unit 204. The analytics processing unit 204 may be configured to identify event data associated with a particular event in the received event data and/or the event storage unit 208, such as based on a received request for economic impact and/or transaction behaviors. The analytics processing unit 204 may be further configured to identify, in the received transaction data and/or the transaction storage unit, transaction data for payment transactions that occurred in within a particular time frame of the particular event and within a specified area of a location of the particular event. The specified area may be a predetermined area surrounding the venue 102, may be the particular market 104, or other suitable area as will be apparent to persons having skill in the relevant art.

The analytics processing unit 204 may be configured to identify the economic impact of the particular event on the particular market 104 based on the identified transaction data. In some instances, the economic impact may be with respect to the outcome of the corresponding event. The analytics processing unit 204 may also be configured to identify consumer transaction behaviors associated with the particular event based (e.g., and its outcome) on the identified transaction data. In some instances, the analytics processing unit 204 may store the identified economic impact and/or consumer transaction behavior data in storage in the processing server 114, such as in a memory unit 216 or the event storage unit 208. In some embodiments, the analytics processing unit 204 may be further configured to predict the economic impact of a future event, or consumer transaction behaviors associated with a future event, based on the economic impact and/or consumer transaction behaviors of past events based on event similarity, event/venue similarity, time, weather conditions, economic conditions, odds, polls, etc. In some instances, multiple predictions of the economic impact of a future event may be generated, such as based on possible outcomes. For example, the analytics processing unit 204 may predict the economic impact of one sports team winning for a sporting event, as well as the economic impact of the other sports team winning. Other criteria that may be considered for predictions of future economic impact may include margin of victory (e.g., for a sporting event or election), total score, etc.

In one embodiment, the receiving unit 202 may receive a request for prediction of economic impact and/or consumer transaction behaviors for a future event. The request may include event data associated with the future event. The analytics processing unit 204 may be configured to identify similar events, venues 102, and/or markets 104 based on the event data associated with the future event and event data associated with past events for which economic impact and/or transaction behaviors were determined. The analytics processing unit 204 may then determine a predicted economic impact and/or consumer transaction behaviors for the future event based on the determined economic impact and/or consumer transaction behaviors for the past events (e.g., and stored in the memory unit 216). In instances where multiple economic impacts may be predicted, such as based on outcome of the event, the analytics processing unit 204 may determine each economic impact based on past events with similar outcomes (e.g., home team winning in a sporting event).

The processing server 114 may further include a transmitting unit 206. The transmitting unit 206 may be configured to transmit data over one or more networks via one or more network protocols. The transmitting unit 206 may be configured to transmit determined or predicted economic impact and/or transaction behavior data, in response to received requests for economic impact or transaction behaviors. The transmitting unit 206 may also be configured to transmit requests for data, such as to the event data provider 112, venue 102, merchants 108, payment network 110, or demographic data provider 116.

Process for Determining Economic Impact or Transaction Behaviors Associated with an Event

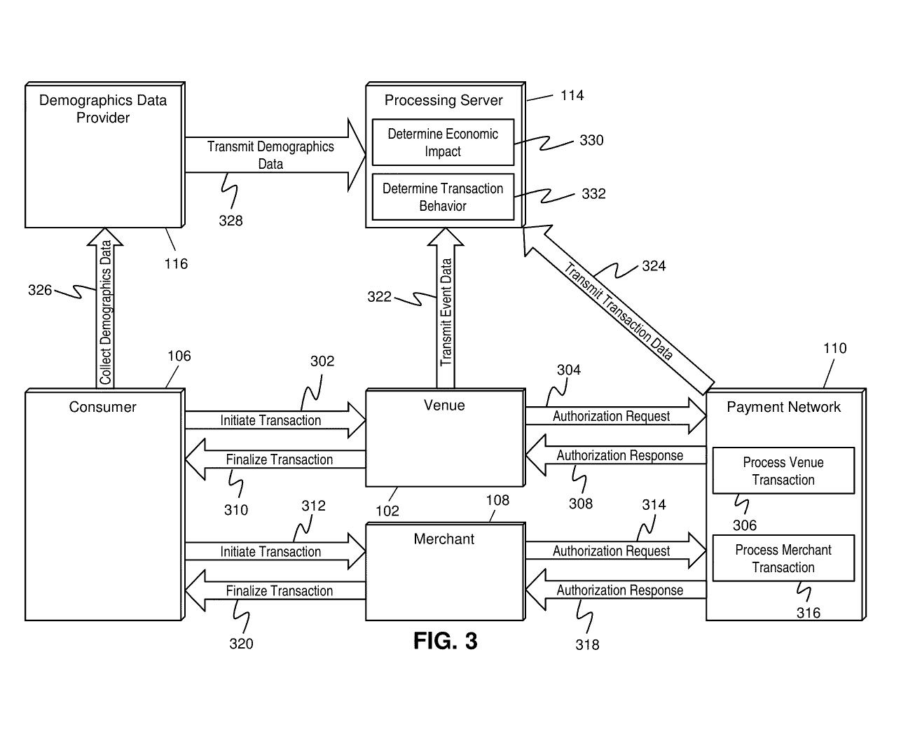

FIG. 3 shows a process for determining the economic impact or consumer transaction behaviors associated with an event using the system 100 of FIG. 1.

In step 302, one or more consumers 106 may initiate payment transactions with the venue 102, such as to attend a particular event. In some instances, the payment transactions may be payment card transactions, which may require authorization by an issuer of a payment card used to fund the transaction. The venue 102 (e.g., or an acquirer associated with the venue 102) may generate an authorization request for the payment transaction and may submit the authorization request, in step 304, to the payment network 110. In step 306, the payment network 110 may process the transaction using methods and systems that will be apparent to persons having skill in the relevant art. Processing of the payment transaction may include storage of transaction data associated with the transaction in a transaction storage unit 210.

In step 308, the payment network 110 may forward an authorization response indicating approval of the payment transaction to the venue 102. The venue 102 may then, in step 310, finalize the transaction with the consumer 106, such as by furnishing a ticket to the event or entry to the event to the consumer 106. It will be apparent to persons having skill in the relevant art that, for some events, steps 302-310 may be optional. For example, in a political event that is not associated with a particular venue 102, such a payment transaction may not occur.

In step 312, one or more consumers 106 may a payment transaction with the merchant 108, such as at a restaurant, hotel, taxi service, airport, souvenir store, tourist attraction, etc. The merchant 108 (e.g., or an acquirer associated with the merchant 108) may, in step 314, generate and submit an authorization request for the transaction to the payment network 110. In step 316, the payment network 110 may process the transaction using methods and systems that will be apparent to persons having skill in the relevant art. Processing of the payment transaction may include storage of transaction data associated with the transaction in a transaction storage unit 210.

In step 318, the payment network 110 may forward an authorization response indicating approval of the transaction to the merchant 108. In step 320, the merchant 108 may finalize the transaction with the consumer 106, such as by furnishing the transacted-for goods or services to the consumer 106 and/or a receipt for the purchase to the consumer 106.

In step 322, the venue 102 (e.g., or the event data provider 112) may transmit event data associated with the event to the processing server 114. The event data may include a time and/or date, outcome of the event, margin of victory, total score, event odds, polling statistics, event type, acts associated with the event, event category, weather conditions, economic conditions, data regarding additional events in the particular market 104 or specified area, and additional data as will be apparent to persons having skill in the relevant art. In step 324, the payment network 110 may transmit transaction data associated with the processed payment transactions to the processing server 114. The transaction data may include transaction times and/or dates, product data, consumer data, merchant data, transaction amounts, geographic locations, and any other suitable data as will be apparent to persons having skill in the relevant art.

In step 326, the demographics data provider 116 may collect demographics data from the consumers 106. It will be apparent to persons having skill in the relevant art that step 326 may be performed prior to any or all of the other steps in the process. The collected demographics data may include age, gender, income, occupation, education, residential status, familial status, marital status, zip code, postal code, and any other suitable demographics as will be apparent to persons having skill in the relevant art. In step 328, the demographics data provider 116 may transmit the collected demographics data to the processing server 114.

In step 330, the analytics processing unit 204 of the processing server 114 may determine an economic impact of the event on the particular market 104 based on the received transaction data, event data, and demographics data. In step 332, the analytics processing unit 204 may determine consumer transaction behaviors associated with the event based on the received transaction data, event data, and demographics data. It will be apparent to persons having skill in the relevant art that, in some instances, only step 330 or step 332 may be performed.

### Determination and Prediction of Economic Impact of Events

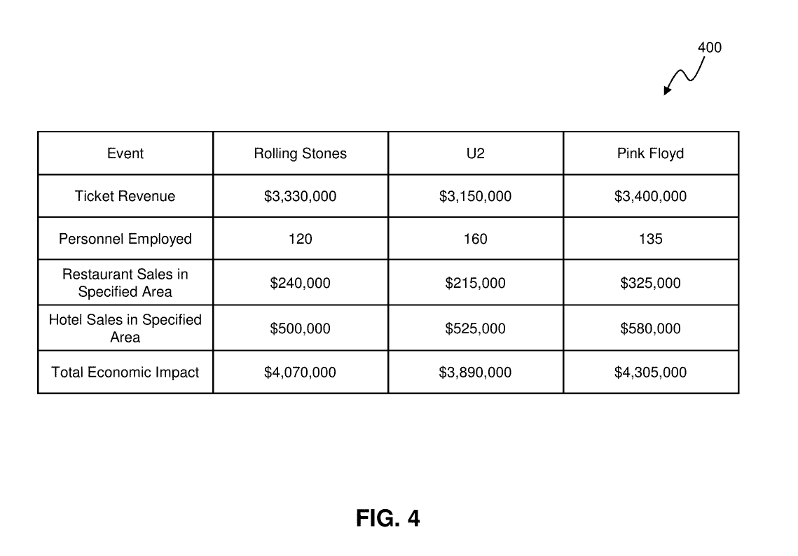

FIG. 4 illustrates a table 400 of the determined economic impact of three events at the venue 102 on the particular market 104 using the processing server 114 of the system 100 of FIG. 1. It will be apparent to persons having skill in the relevant art that the data included in the table 400 is used for illustration purposes and that additional data obtained from the identified transaction data may also be suitable for use in determining the economic impact of an event on a particular market.

Table 400 illustrates three events held at the venue 102 in the particular market 104: a Rolling Stones concert, a U2 concert, and a Pink Floyd concert. The analytics processing unit 204 may receive transaction data from the payment network 110 and may identify, for each of the three events, payment transactions conducted within a particular time frame of each respective event and within a specified area located around the venue 102. In some instances, the particular time frame and/or specified area may be based on the type of event. For example, the time frame for a multiple day festival may be longer than the time frame for a two hour concert. Similarly, the specified area for a large, single occurring or annual event, such as a music festival, may be larger than the area for a concert on a tour that stops in multiple, nearby cities.

The analytics processing unit 204 may then identify suitable values for the determination of the economic impact for the event. As illustrated in the table 400, the analytics processing unit 204 may identify ticket revenue for the event, the number of personnel employed as a result of the event (e.g., included in the event data), restaurant sales in the specified area, and hotel sales in the specified area. The analytics processing unit 204 may then determine the economic impact of the event based on the identified data. For example, as illustrated in the table 400, the overall economic impact of the Rolling Stones concert may be determined to be $4,070,000.

It will be apparent to persons having skill in the relevant art that additional data may be included in the determination of the economic impact. For example, the analytics processing unit 204 may also identify data regarding taxi sales, public transportation revenue, retail sales, concessions and retail sales at the venue 102, etc. In addition, such additional data may be based on the type of event. For example, the analytics processing unit 204 may also identify data regarding rental car services for multiple-day events.

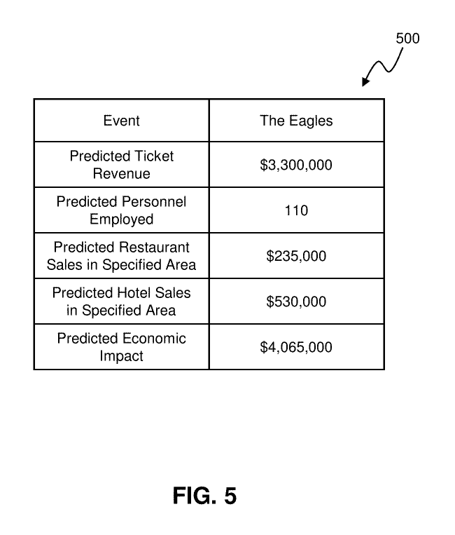

FIG. 5 illustrates a table 500 of the predicted economic impact of a future event at the venue 102, an Eagles concert. As illustrated in table 500, the analytics processing unit 204 may determine predictions for each of the types of data identified for the past events, such as based on event data regarding the future event (e.g., ticket sales, act popularity, impact at other venues on the same tour or previous tours, etc.) and similarities with the previous events. For example, as illustrated in the table 500, the analytics processing unit 204 may determine that the ticket revenue for the future Eagles concert will be comparable to the revenue for the Rolling Stones concert, but that the hotel sales will be higher and more comparable to the hotel sales for the U2 concert.

Determination and Prediction of Transaction Behaviors Associated with an Event

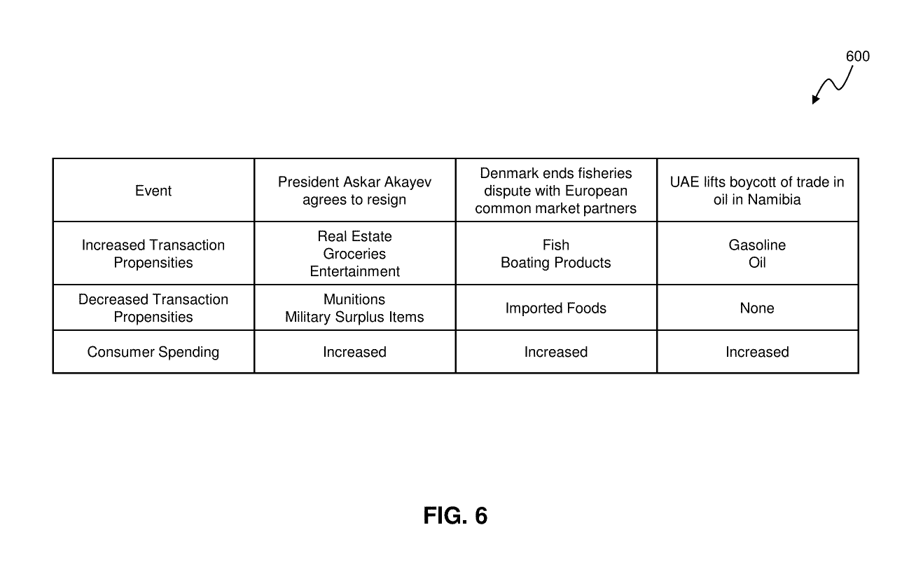

FIG. 6 illustrates a table 600 of the determined consumer transaction behaviors associated with three events using the processing server 114 of the system 100 of FIG. 1. It will be apparent to persons having skill in the relevant art that the data included in the table 600 is used for illustration purposes and that additional data obtained from the identified transaction data may also be suitable for use in determining the consumer transaction behaviors associated with an event. Furthermore, the table 600 illustrates transaction behaviors associated with political events. It will be apparent to persons having skill in the relevant art that transaction behaviors and/or considerations thereof may be different for a different type of event.

The table 600 illustrates three political events that occurred in different markets 104 for which consumer transaction behaviors were determined using the analytics processing unit 204 of the processing server 114. Each event may be associated with a Conflict and Mediation Event Observations (CAMEO) code based on guidelines included in the CAMEO codebook. For example, the resignation of Askar Akayev and his agreement to not return to Kyrgyzstan may be associated with CAMEO code 0341, which corresponds to an express intent to change leadership. The CAMEO code for an event may be included in the event data associated with the event, and used by the analytics processing unit 204 in the determination or prediction of transaction behaviors associated with the event. As illustrated in the table 600, the analytics processing unit 204 may determine, based on transaction data for transactions conducted within a specified area associated with the event, increased and/or decreased propensities for consumers to transact with respect to merchant and/or product categories. For example, consumers may have shown higher propensities to purchase real estate and groceries and spend on entertainment following the resignation of President Akayev and may have shown a lower propensity to purchase munitions or military surplus items. In addition, the analytics processing unit 204 may have identified an overall increase in consumer spending in the specified area following the resignation. This information can then be used to predict the economic impact of possible planned change of leadership, that might have an effect on the desire for and/or timing of a planned or contemplated political event.

Transaction behaviors that may be determined by the analytics processing unit 204 may include propensities for consumers 106 to transact based on merchant types, merchant categories, merchant industries, product types, product categories, event types, and other suitable behaviors as will be apparent to persons having skill in the relevant art. Furthermore, transaction behaviors determined by the processing server 114 may be based on the type of event. For example, determined transaction behaviors for a sporting event may include propensities to transact at sporting goods stores, while transaction behaviors for a musical event may include propensities to transact at music stores. In some instances, transaction behaviors may be with respect to outcomes of the event, such as the winner, margin of victory, etc.

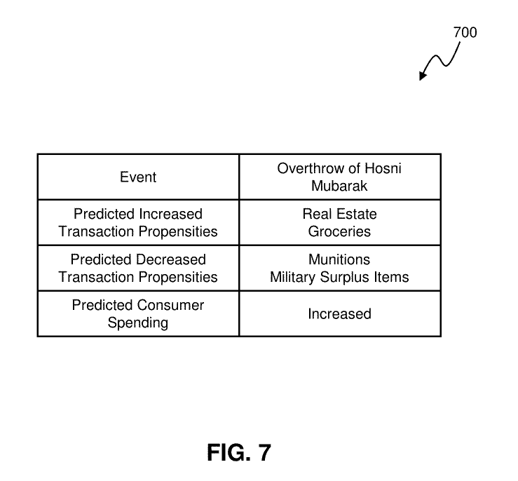

FIG. 7 illustrates a table 700 of the predicted transaction behaviors of a planned or contemplated political event, the overthrow of Hosni Mubarak. As illustrated in table 700, the analytics processing unit 204 may determine predictions for each of the transaction behaviors of the past political events, such as based on event data regarding the planned or contemplated event and similarities with the previous events. Similarities can be additionally measured by automated political speech quantification coding, such as the associated CAMEO code. For example, the overthrow of Hosni Mubarak may be determined to be more closely associated with the resignation of President Akayev than the other past events due to the common CAMEO code or other measures of nature of the event, a regime change. Thus, instead of an overthrow, political leaders might be motived to take a different course based in part on the predicted impact on the economy. The analytics processing unit 204 may predict the transaction behaviors, which, as illustrated in the example table 700, may be the same as the behaviors of the consumers 106 following the resignation of President Akayev, but without an increased propensity to spend on entertainment.

### Exemplary Method for Determining Economic Impact of an Event on a Particular Market

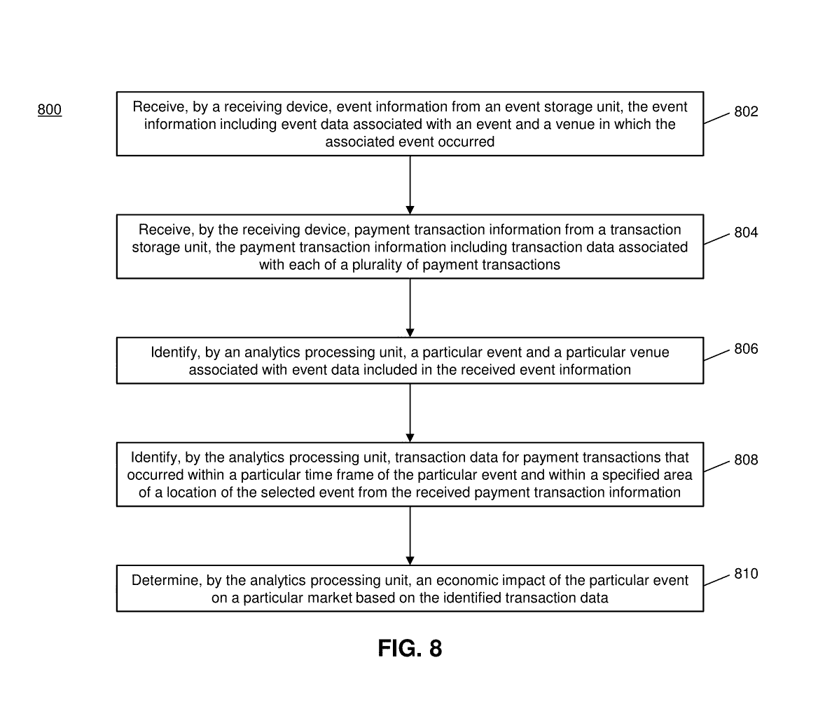

FIG. 8 illustrates a method 800 for the performing of analytics processing in the processing server 114 in order to determine the economic impact of an event on a particular market (e.g., the particular market 104).

In step 802, event information may be received, by a receiving device (e.g., the receiving unit 202), from an event storage unit (e.g., the event storage unit 208), wherein the event information includes event data associated with an event and a venue (e.g., the venue 102) in which the associated event occurred. In step 804, payment transaction information may be received, by the receiving device 202, from a transaction storage unit (e.g., the transaction storage unit 210), wherein the payment transaction information includes transaction data associated with each of a plurality of payment transactions.

In step 806, a particular event and a particular venue 102 associated with event data included in the received event information may be identified by an analytics processing unit (e.g., the analytics processing unit 204). In one embodiment, the analytics processing unit 204 may be included in a payment network (e.g., the payment network 110). In step 808, transaction data for payment transactions that occurred within a particular time frame of the particular event and within a specified area of a location of the selected event may be identified, by the analytics processing unit 204, from the received payment transaction information.

In step 810, an economic impact of the particular event on a particular market (e.g., the particular market 104) may be determined, by the analytics processing unit 204, based on the identified transaction data. In some embodiments, determining the economic impact may include determining the amount of money spent on at least one of: hotel rooms, restaurants, entertainment, and travel in the specified area during the particular time frame of the particular event. In one embodiment, determining the economic impact may include determining whether purchases of a merchant type have increased in the particular market 104 due to the particular event, and, if the purchases of the merchant type are determined to have increased, determining the amount of the increase. In another embodiment, the event information may further include an outcome corresponding to the associated event, and the determined economic impact of the particular event may be an economic impact of the particular event with the corresponding outcome

In one embodiment, the method 800 may further include receiving, by the receiving device 202, demographics information from a demographics storage unit (e.g., the demographics storage unit 214), wherein the demographics information includes demographic data of a plurality of individuals that attended the particular event. In another embodiment, the method 800 may further include receiving, by the receiving device 202, merchant information from a merchant storage unit (e.g., the merchant storage unit 212), wherein the merchant information includes a list of merchants (e.g., the merchants 108) present in the specified area within the particular time frame of the particular event.

In some embodiments, the method 800 may further include predicting, by the analytics processing unit 204, a future economic impact of a future event on the particular market 104 based on a determined economic impact of similar events on the particular market 104. In another embodiment, the method 800 may further include predicting, by the analytics processing unit 204, a future economic impact of a future event on the particular market 104 based on payment transaction information of individuals that attended a past similar event.

In one embodiment, the method 800 may further include: identifying, by the analytics processing unit 204, individuals (e.g., the consumers 106) that attended the selected event based on the transaction data included in the received payment transaction information; identifying, by the analytics processing unit 204, transaction data associated with payment transactions included in the received payment transaction information involving the identified individuals 106 conducted within the particular time frame of the particular event and within the specified area of the location of the particular event; and determining, by the analytics processing unit 204, types of purchases by the identified individuals 106 during the particular time frame of the particular event and within the specified area of the location of the event based on the identified transaction data. In a further embodiment, determining the economic impact of the event may include determining the amount of money spent on at least one of: hotel rooms, restaurants, entertainment, and travel by the identified individuals 106 in the specified area during the particular time frame of the particular event.

Exemplary Method for Determining Transaction Behaviors Associated with an Event

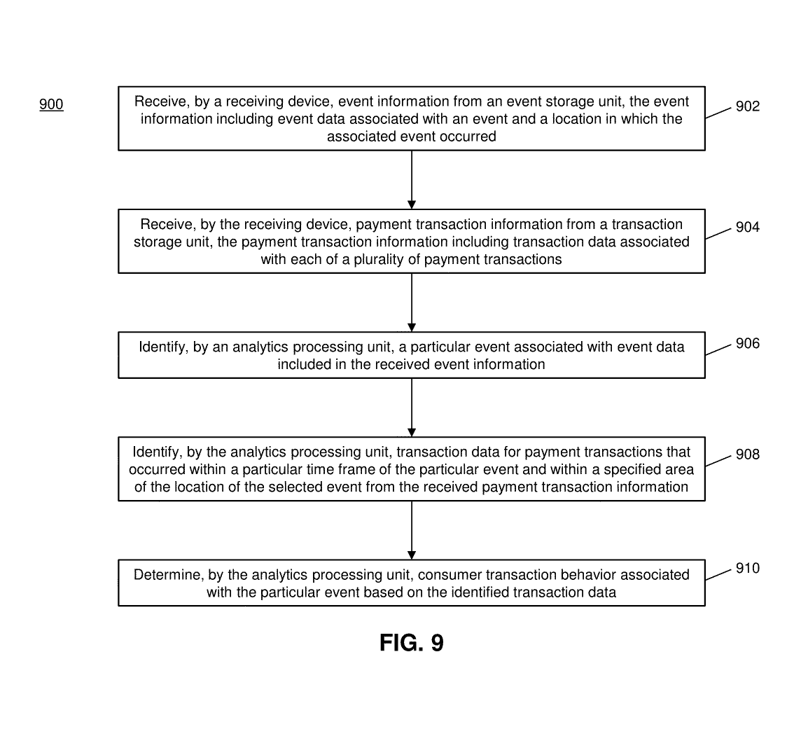

FIG. 9 illustrates a method 900 for the performing of analytics processing in the processing server 114 in order to determine the economic impact of an event on a particular market (e.g., the particular market 104).

In step 902, event information may be received, by a receiving device (e.g., the receiving unit 202), from an event storage unit (e.g., the event storage unit 208), wherein the event information includes event data associated with an event and a location in which the associated event occurred. In step 904, payment transaction information may be received, by the receiving device 202, from a transaction storage unit (e.g., the transaction storage unit 210), wherein the payment transaction information includes transaction data associated with each of a plurality of payment transactions.

In step 906, a particular event and associated with event data included in the received event information may be identified by an analytics processing unit (e.g., the analytics processing unit 204). In one embodiment, the analytics processing unit 204 may be included in a payment network (e.g., the payment network 110). In step 908, transaction data for payment transactions that occurred within a particular time frame of the particular event and within a specified area of the location of the selected event may be identified, by the analytics processing unit 204, from the received payment transaction information.

In step 910, consumer transaction behavior associated with the particular event may be determined, by the analytics processing unit 204, based on the identified transaction data. In some embodiments, determining the economic impact may include determining spending propensities and behaviors for at least one of: one or more types of merchants, one or more types of products, one or more types of events, and one or more types of industries. In one embodiment, determining the economic impact may include determining whether purchases of a merchant type have increased in the particular market 104 due to the particular event, and, if the purchases of the merchant type are determined to have increased, determining the amount of the increase. In some embodiments, the event information may further include an outcome corresponding to the associated event, and the determined consumer transaction behavior associated with the particular event may be consumer transaction behavior associated with the particular event and corresponding outcome

In one embodiment, the method 900 may further include receiving, by the receiving device 202, demographics information from a demographics storage unit (e.g., the demographics storage unit 214), wherein the demographics information includes demographic data of a plurality of individuals involved in the particular event. In another embodiment, the method 900 may further include receiving, by the receiving device 202, merchant information from a merchant storage unit (e.g., the merchant storage unit 212), wherein the merchant information includes a list of merchants (e.g., the merchants 108) present in the specified area within the particular time frame of the particular event.

In some embodiments, the method 900 may further include predicting, by the analytics processing unit 204, future consumer transaction behavior associated with a future event in the specified area based on determined consumer transaction behavior associated with similar events in the specified area. In another embodiment, the method 900 may further include identifying, by the analytics processing unit 204, individuals impacted by or involved in the particular event based on the identified transaction data.

In one embodiment, the method 900 may further include: identifying, by the analytics processing unit 204, individuals (e.g., the consumers 106) involved in the selected event based on the transaction data included in the received payment transaction information; identifying, by the analytics processing unit 204, transaction data associated with payment transactions included in the received payment transaction information involving the identified individuals 106 conducted within the particular time frame of the particular event and within the specified area of the location of the particular event; and determining, by the analytics processing unit 204, types of purchases by the identified individuals 106 during the particular time frame of the particular event and within the specified area of the location of the event based on the identified transaction data. In a further embodiment, determining the economic impact of the event may include spending propensities and behaviors for at least one of: one or more types of merchants, one or more types of products, one or more types of events, and one or more types of industries for the identified individuals in the specified area during the particular time frame of the particular event.

### Computer System Architecture

FIG. 10 illustrates a computer system 1000 in which embodiments of the present disclosure, or portions thereof, may be implemented as computer-readable code. For example, the processing server 114 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 8, and 9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor 1004 may be a special purpose or a general purpose processor device. The processor 1004 may be connected to a communications infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive or universal serial bus port, the removable storage unit 1018 may be a floppy disk or portable flash drive, respectively. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

The computer system 1000 may further include a display interface 1002. The display interface 1002 may be configured to allow data to be transferred between the computer system 1000 and external display 1030. Exemplary display interfaces 1002 may include high-definition multimedia interface (HDMI), digital visual interface (DVI), video graphics array (VGA), etc. The display 1030 may be any suitable type of display for displaying data transmitted via the display interface 1002 of the computer system 1000, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1008 and secondary memory 1010, which may be memory semiconductors (e.g., DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 3, 8, and 9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for determining an economic impact of an event and transaction behaviors associated with an event. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for performing analytics processing in order to determine economic impact of an event on a particular market, comprising:
receiving, by a receiving device, event information from an event storage unit, the event information including event data associated with an event and a venue in which the associated event occurred;
receiving, by the receiving device, payment transaction information from a transaction storage unit, the payment transaction information including transaction data associated with each of a plurality of payment transactions;
identifying, by an analytics processing unit, a particular event and a particular venue associated with event data included in the received event information;
identifying, by the analytics processing unit, transaction data for payment transactions that occurred within a particular time frame of the particular event and within a specified area of a location of the selected event from the received payment transaction information; and
determining, by the analytics processing unit, an economic impact of the particular event on a particular market based on the identified transaction data.

2. The method of claim 1, wherein determining the economic impact includes determining an amount of money spent on at least one of: hotel rooms, restaurants, entertainment, and travel in the specified area during the particular time frame of the particular event.

3. The method of claim 1, further comprising:
identifying, by the analytics processing unit, individuals that attended the selected event based on the transaction data included in the received payment transaction information;
identifying, by the analytics processing unit, transaction data associated with payment transactions included in the received payment transaction information involving the identified individuals conducted within the particular time frame of the particular event and within the specified area of the location of the particular event; and
determining, by the analytics processing unit, types of purchases by the identified individuals during the particular time frame of the particular event and within the specified area of the location of the event based on the identified transaction data.

4. The method of claim 3, wherein determining the economic impact includes determining an amount of money spent on at least one of: hotel rooms, restaurants, entertainment, and travel by the identified individuals in the specified area during the particular time frame of the particular event.

5. The method of claim 1, further comprising:
predicting, by the analytics processing unit, a future economic impact of a future event on the particular market based on a determined economic impact of similar events on the particular market.

6. The method of claim 1, further comprising:
predicting, by the analytics processing unit, a future economic impact of a future event on the particular market based on payment transaction information of individuals that attended a past similar event.

7. The method of claim 1, wherein determining the economic impact includes determining whether purchases of a merchant type have increased in the particular market due to the particular event, and, if the purchases of the merchant type are determined to have increased, further determining an amount of increase.

8. The method of claim 1, wherein the analytics processing unit is included in a payment network.

9. The method of claim 1, further comprising:
receiving, by the receiving device, demographics information from a demographics storage unit, the demographics information including demographic data of a plurality of individuals that attended the particular event.

10. The method of claim 1, further comprising:
receiving, by the receiving device, merchant information from a merchant storage unit, the merchant information including a list of merchants present in the specified area within the particular time frame of the particular event.

11. The method of claim 1, wherein the event information further includes an outcome corresponding to the associated event, and wherein the determined economic impact of the particular event is an economic impact of the particular event with the corresponding outcome.

12. A method for performing analytics processing in order to determine transaction behaviors associated with an event, comprising:
receiving, by a receiving device, event information from an event storage unit, the event information including event data associated with an event and a location in which the associated event occurred;
receiving, by the receiving device, payment transaction information from a transaction storage unit, the payment transaction information including transaction data associated with each of a plurality of payment transactions;
identifying, by an analytics processing unit, a particular event associated with event data included in the received event information;
identifying, by the analytics processing unit, transaction data for payment transactions that occurred within a particular time frame of the particular event and within a specified area of the location of the selected event from the received payment transaction information; and
determining, by the analytics processing unit, consumer transaction behavior associated with the particular event based on the identified transaction data.

13. The method of claim 12, wherein determining consumer transaction behavior includes determining spending propensities and behaviors for at least one of: one or more types of merchants, one or more types of products, one or more types of events, and one or more types of industries.

14. The method of claim 12, further comprising:
identifying, by the analytics processing unit, individuals involved in the selected event based on the transaction data included in the received payment transaction information;
identifying, by the analytics processing unit, transaction data associated with payment transactions included in the received payment transaction information involving the identified individuals conducted within the particular time frame of the particular event and within the specified area of the location of the particular event; and
determining, by the analytics processing unit, types of purchases by the identified individuals during the particular time frame of the particular event and within the specified area of the location of the event based on the identified transaction data.

15. The method of claim 14, wherein determining consumer transaction behavior includes determining spending propensities and behaviors for at least one of: one or more types of merchants, one or more types of products, one or more types of events, and one or more types of industries for the identified individuals in the specified area during the particular time frame of the particular event.

16. The method of claim 12, further comprising:
predicting, by the analytics processing unit, future consumer transaction behavior associated with a future event in the specified area based on determined consumer transaction behavior associated with similar events in the specified area.

17. The method of claim 12, wherein determining consumer transaction behavior includes determining whether purchases of a merchant type have increased in the specified area due to the particular event, and, if the purchases of the merchant type are determined to have increased, further determining an amount of increase.

18. The method of claim 12, wherein the analytics processing unit is included in a payment network.

19. The method of claim 12, further comprising:
receiving, by the receiving device, demographics information from a demographics storage unit, the demographics information including demographic data of a plurality of individuals involved in the particular event.

20. The method of claim 12, further comprising:
receiving, by the receiving device, merchant information from a merchant storage unit, the merchant information including a list of merchants present in the specified area within the particular time frame of the particular event.

21. The method of claim 12, further comprising:
identifying, by the analytics processing unit, individuals impacted by or involved in the particular event based on the identified transaction data.

22. The method of claim 12, wherein the event information further includes an outcome corresponding to the associated event, and wherein the determined consumer transaction behavior associated with the particular event is consumer transaction behavior associated with the particular event and corresponding outcome.

23. A system for performing analytics processing in order to determine economic impact of an event on a particular market, comprising:
a receiving device configured to receive
event information from an event storage unit, the event information including event data associated with an event and a venue in which the associated event occurred, and
payment transaction information from a transaction storage unit, the payment transaction information including transaction data associated with each of a plurality of payment transactions; and
an analytics processing unit configured to
identify a particular event and a particular venue associated with event data included in the received event information,
identify transaction data for payment transactions that occurred within a particular time frame of the particular event and within a specified area of a location of the selected event from the received payment transaction information, and
determine an economic impact of the particular event on a particular market based on the identified transaction data.

24. The system of claim 23, wherein determining the economic impact includes determining an amount of money spent on at least one of: hotel rooms, restaurants, entertainment, and travel in the specified area during the particular time frame of the particular event.

25. The system of claim 23, wherein the analytics processing unit is further configured to:
Identify individuals that attended the selected event based on the transaction data included in the received payment transaction information;
Identify transaction data associated with payment transactions included in the received payment transaction information involving the identified individuals conducted within the particular time frame of the particular event and within the specified area of the location of the particular event; and
determine types of purchases by the identified individuals during the particular time frame of the particular event and within the specified area of the location of the event based on the identified transaction data.

26. The system of claim 25, wherein determining the economic impact includes determining an amount of money spent on at least one of: hotel rooms, restaurants, entertainment, and travel by the identified individuals in the specified area during the particular time frame of the particular event.

27. The system of claim 23, wherein the analytics processing unit is further configured to predict a future economic impact of a future event on the particular market based on a determined economic impact of similar events on the particular market.

28. The system of claim 23, wherein the analytics processing unit is further configured to predict a future economic impact of a future event on the particular market based on payment transaction information of individuals that attended a past similar event.

29. The system of claim 23, wherein determining the economic impact includes determining whether purchases of a merchant type have increased in the particular market due to the particular event, and, if the purchases of the merchant type are determined to have increased, further determining an amount of increase.

30. The system of claim 23, wherein the analytics processing unit is included in a payment network.

31. The system of claim 23, wherein the receiving device is further configured to receive demographics information from a demographics storage unit, the demographics information including demographic data of a plurality of individuals that attended the particular event.

32. The system of claim 23, wherein the receiving device is further configured to receive merchant information from a merchant storage unit, the merchant information including a list of merchants present in the specified area within the particular time frame of the particular event.

33. The system of claim 23, wherein the event information further includes an outcome corresponding to the associated event, and wherein the determined economic impact of the particular event is an economic impact of the particular event with the corresponding outcome.

34. A system for performing analytics processing in order to determine transaction behaviors of an event on a particular area, comprising:
a receiving device configured to receive
event information from an event storage unit, the event information including event data associated with an event and a location in which the associated event occurred, and
payment transaction information from a transaction storage unit, the payment transaction information including transaction data associated with each of a plurality of payment transactions; and
an analytics processing unit configured to
identify a particular event associated with event data included in the received event information,
identify transaction data for payment transactions that occurred within a particular time frame of the particular event and within a specified area of the location of the selected event from the received payment transaction information, and
determine consumer transaction behavior associated with the particular event based on the identified transaction data.

35. The system of claim 34, wherein determining consumer transaction behavior includes determining spending propensities and behaviors for at least one of: one or more types of merchants, one or more types of products, one or more types of events, and one or more types of industries.

36. The system of claim 34, wherein the analytics processing unit is further configured to:
identify individuals involved in the selected event based on the transaction data included in the received payment transaction information;
identify transaction data associated with payment transactions included in the received payment transaction information involving the identified individuals conducted within the particular time frame of the particular event and within the specified area of the location of the particular event; and
determine types of purchases by the identified individuals during the particular time frame of the particular event and within the specified area of the location of the event based on the identified transaction data.

37. The system of claim 36, wherein determining consumer transaction behavior includes determining spending propensities and behaviors for at least one of: one or more types of merchants, one or more types of products, one or more types of events, and one or more types of industries for the identified individuals in the specified area during the particular time frame of the particular event.

38. The system of claim 34, wherein the analytics processing unit is further configured to predict future consumer transaction behavior associated with a future event in the specified area based on determined consumer transaction behavior associated with similar events in the specified area.

39. The system of claim 34, wherein determining consumer transaction behavior includes determining whether purchases of a merchant type have increased in the specified area due to the particular event, and, if the purchases of the merchant type are determined to have increased, further determining an amount of increase.

40. The system of claim 34, wherein the analytics processing unit is included in a payment network.

41. The system of claim 34, wherein the receiving device is further configured to receive demographics information from a demographics storage unit, the demographics information including demographic data of a plurality of individuals involved in the particular event.

42. The system of claim 34, wherein the receiving device is further configured to receive merchant information from a merchant storage unit, the merchant information including a list of merchants present in the specified area within the particular time frame of the particular event.

43. The system of claim 34, wherein the analytics processing unit is further configured to identify individuals impacted by or involved in the particular event based on the identified transaction data.

44. The system of claim 34, wherein the event information further includes an outcome corresponding to the associated event, and wherein the determined consumer transaction behavior associated with the particular event is consumer transaction behavior associated with the particular event and corresponding outcome.
